(19) United States
(12) Patent Application Publication
(10) Pub. No.: US 2022/0164159 A1
(43) Pub. Date: May 26, 2022

(54) METHOD FOR PLAYING AUDIO, TERMINAL AND COMPUTER-READABLE STORAGE MEDIUM

(71) Applicant: GUANGZHOU KUGOU COMPUTER TECHNOLOGY CO., LTD., Guangzhou (CN)

(72) Inventors: Jiaze LIU, Guangzhou (CN); Zhonglan LUO, Guangzhou (CN)

(21) Appl. No.: 17/383,057

(22) Filed: Jul. 22, 2021

(30) Foreign Application Priority Data
Nov. 26, 2020 (CN) 202011349663.6

(51) Int. Cl. G06F 3/16; G06F 3/0486; G06F 3/0481; G06F 3/0488; G06F 3/0484

(52) U.S. Cl. CPC G06F 3/165; G06F 3/0486; G06F 3/04842; G06F 3/0488; G06F 3/04815

(57) ABSTRACT

A method for playing audio, applicable to a terminal and including: displaying a virtual scene acquired based on a real scene; acquiring a corresponding position of the terminal in the virtual scene by mapping a position of the terminal in the real scene to the virtual scene; adjusting a volume parameter of at least one virtual sound box based on a relative positional relationship between the at least one virtual sound box and the terminal in the virtual scene; and playing audio based on the volume parameter of the at least one virtual sound box.

This application claims priority to the Chinese Patent Application No. 202011349663.6, filed on Nov. 26, 2020 and entitled “METHOD AND APPARATUS FOR PLAYING AUDIO, TERMINAL AND COMPUTER-READABLE STORAGE MEDIUM”, the disclosure of which is herein incorporated by reference in its entirety.

### TECHNICAL FIELD

Embodiments of the present disclosure relate to the field of computer technologies, and in particular, to a method for playing audio, a terminal, and a computer-readable storage medium.

### BACKGROUND

With the increasing requirements of users on audio play effects, current terminals can provide multiple audio effects. The users can select one audio effect from the multiple audio effects, and then play audio based on the selected audio effect so as to listen to audio matching the audio effect.

### SUMMARY

In one aspect, a method for playing audio is provided. The method includes:

displaying a virtual scene acquired based on a real scene;

acquiring a corresponding position of the terminal in the virtual scene by mapping a position of the terminal in the real scene to the virtual scene;

adjusting a volume parameter of at least one virtual sound box based on a relative positional relationship between the at least one virtual sound box and the terminal in the virtual scene; and

playing audio based on the volume parameter of the at least one virtual sound box.

In another aspect, a terminal is provided. The terminal includes a processor and a memory, wherein at least one program code is stored in the memory, and the at least one program code is loaded and executed by the processor to implement the following operations of:

displaying a virtual scene acquired based on a real scene;

acquiring a corresponding position of the terminal in the virtual scene by mapping a position of the terminal in the real scene to the virtual scene;

adjusting a volume parameter of the at least one virtual sound box based on a relative positional relationship between at least one virtual sound box and the terminal in the virtual scene; and

playing audio based on the volume parameter of the at least one virtual sound box.

In another aspect, a computer-readable storage medium is provided. At least one program code is stored in the computer-readable storage medium, and the at least one program code is loaded and executed by a processor to implement the following operations of:

displaying a virtual scene acquired based on a real scene;

acquiring a corresponding position of the terminal in the virtual scene by mapping a position of the terminal in the real scene to the virtual scene;

adjusting a volume parameter of at least one virtual sound box based on a relative positional relationship between the at least one virtual sound box and the terminal in the virtual scene; and

playing audio based on the volume parameter of the at least one virtual sound box.

In yet another aspect, a computer program product or a computer program is provided. The computer program product or computer program includes a computer program code, and the computer program code is stored in a computer-readable storage medium. A processor of the terminal reads the computer program code from the computer-readable storage medium. The processor executes the computer program code, so that the terminal implements the following operations of:

displaying a virtual scene acquired based on a real scene;

acquiring a corresponding position of the terminal in the virtual scene by mapping a position of the terminal in the real scene to the virtual scene;

adjusting a volume parameter of at least one virtual sound box based on a relative positional relationship between the at least one virtual sound box and the terminal in the virtual scene; and

playing audio based on the volume parameter of the at least one virtual sound box.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a flowchart of a method for playing audio according to an embodiment of the present disclosure;

FIG. 2 is a flowchart of a method for playing audio according to an embodiment of the present disclosure;

FIG. 3 is a schematic diagram of a display interface according to an embodiment of the present disclosure;

FIG. 4 is a schematic diagram of a display interface according to an embodiment of the present disclosure;

FIG. 5 is a flowchart of a method for playing audio according to an embodiment of the present disclosure;

FIG. 6 is a schematic structural diagram of an apparatus for playing audio according to an embodiment of the present disclosure;

FIG. 7 is a schematic structural diagram of another apparatus for playing audio according to an embodiment of the present disclosure; and

FIG. 8 is a schematic structural diagram of a terminal according to an embodiment of the present disclosure.

### DETAILED DESCRIPTION

The embodiments of the present disclosure provide a method for playing audio, a terminal, and a computer-readable storage medium, which realize the effect that the audio play effect can change with the movement of a terminal in the process of playing the audio, thereby expanding the audio play function, and improving the audio play effect. The technical solution is as follows.

For clearer descriptions of the objectives, technical solutions, and advantages of the present disclosure, embodiments of the present disclosure are described in detail hereinafter with reference to the accompanying drawings.

It can be understood that the terms “first”, “second”, “third”, “fourth”, “fifth”, “sixth”, etc., used in the present disclosure can be configured to describe respective concepts herein. These concepts are not limited by the terms unless otherwise specified. These terms are only configured to distinguish one concept from another.

For the terms “each”, “a plurality of”, “at least one”, “any one” etc., used in the present disclosure, “at least one” includes one, two or more than two, “a plurality of” includes two or more than two, “each” refers to each of the corresponding plurality, and “any one” refers to any one of the plurality. For example, “a plurality of” elements include 3 elements, “each” refers to each of these 3 elements, and “any one” refers to any one of these 3 elements, which may be the first one, the second one, or the third one.

Firstly, the terms involved in the present disclosure are explained:

Augmented reality technology: AR technology for short, the technology can ingeniously combine virtual information with a real environment. For example, the terminal may collect a current real scene, then construct the real scene as a virtual scene, and then add virtual items to the virtual scene, so as to simulate the effect of adding real items to the real scene.

Audio effect: in the audio play process, the terminal may adopt different audio effects for playing. The audio effect is a digital sound effect, an environmental sound effect, a stereo sound effect, a 3D sound effect, and so on. For example, a concert sound effect may be configured to play the audio to simulate an effect of listening to the audio in a concert.

The stereo sound effect may also be configured to play the audio to simulate an effect of listening to the audio in a stereo space. Or other audio effects may be configured to play the audio.

The method according to the embodiment of the present disclosure is applied to the field of audio playing. By using the method according to the embodiment of the present disclosure, a user can set different virtual sound boxes in the virtual scene, each virtual sound box has a volume parameter, and the position of the terminal in the real scene can be mapped to the virtual scene. Then, when the position of the terminal in the real scene changes, a position mapped to the virtual scene will also change. According to a relative positional relationship between the virtual sound box and the terminal in the virtual scene, the volume parameter of each virtual sound box can be adjusted, and then the adjusted volume parameter is adopted to play the audio.

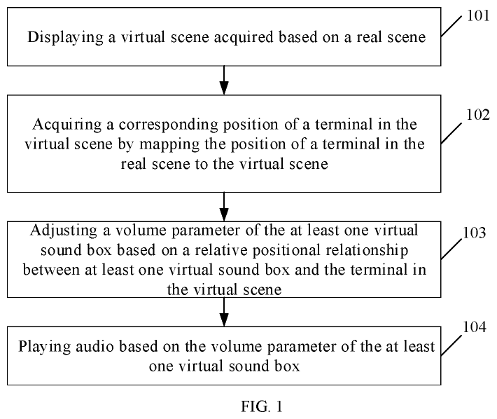

FIG. 1 is a flowchart of a method for playing audio according to an embodiment of the present disclosure. An execution subject of the embodiment of the present disclosure is a terminal. Referring to FIG. 1, the method includes the following steps.

In step 101: a virtual scene acquired based on a real scene is displayed.

In step 102: a corresponding position of a terminal in the virtual scene is acquired by mapping a position of the terminal in the real scene to the virtual scene.

In step 103: a volume parameter of at least one virtual sound box is adjusted based on a relative positional relationship between the at least one virtual sound box and the terminal in the virtual scene.

In step 104: audio is played based on the volume parameter of the at least one virtual sound box.

In the related art, the user selects one audio effect, and then uses such audio effect to play the audio. The function is single and the audio play effect is poor.

In the solution of combining the virtuality and reality to play the audio according to the embodiment of the present disclosure, the virtual sound box can be disposed in the virtual scene corresponding to the real scene, and the volume parameter of the virtual sound box is adjusted based on the relative positional relationship between the terminal and the virtual sound box, so that the adjusted volume parameter is adopted to play the audio. The AR technology is combined with the audio technology. The user moves in the real scene, which changes the relative positional relationship between the terminal and the virtual sound box in the virtual scene, and the volume parameter of the virtual sound box will also change with the movement of the user. Therefore, the effect that the user moves in the real scene to listen to the audios played with different volume parameters is realized, the audio play effect is improved and the audio play function is expanded.

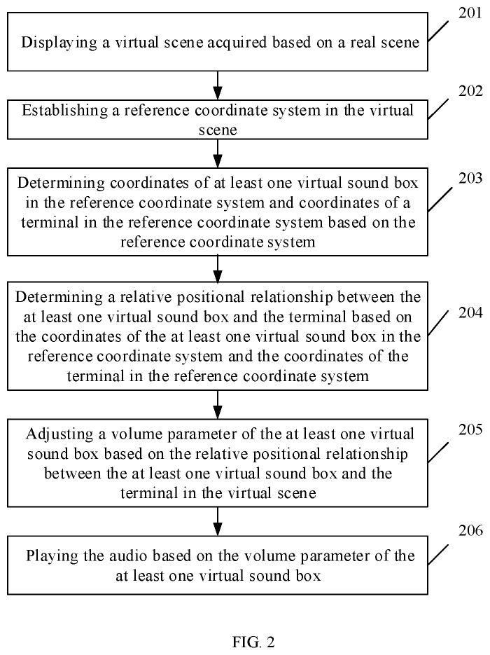

FIG. 2 is a flowchart of a method for playing audio according to an embodiment of the present disclosure. Referring to FIG. 2, the method is applied to the terminal. The terminal is a mobile phone, a tablet computer, a computer, and other types of terminals. The method includes the following steps.

In step 201: a virtual scene acquired based on the real scene is displayed.

The real scene is a scene where the terminal is currently disposed. The virtual scene is a virtual scene corresponding to the real scene where the terminal is currently disposed.

The real scene includes different types of scenes. For example, the real scene is a football field, an office, a concert hall, or other types of scenes.

In the embodiment of the present disclosure, the terminal collects a target image corresponding to the real scene, and may acquire the virtual scene corresponding to the target image.

Optionally, in a case that the real scene is a scene included in the image collected by the terminal, the terminal may collect the target image corresponding to the real scene, construct a target three-dimensional coordinate system of the real scene based on the target image, establish a mapping relationship between the target three-dimensional coordinate system and a virtual three-dimensional coordinate system of an interface displaying the virtual scene, and acquire the virtual scene corresponding to the target image based on the mapping relationship.

The virtual scene acquired by the terminal corresponds to the real scene included in the target image, and an activity of the terminal in the real scene may be simulated through the virtual scene.

In the embodiment of the present disclosure, after acquiring the target image, the terminal may construct the target three-dimensional coordinate system of the real scene by identifying the real scene in the target image. At this time, each object in the real scene has a corresponding position. Then the mapping relationship between the target three-dimensional coordinate system and the virtual three-dimensional coordinate system of the interface displaying the virtual scene is established, and the real scene is mapped to the virtual scene based on the mapping relationship, so that the virtual scene corresponding to the target image can be acquired.

In addition, in the process of acquiring the virtual scene through the target image, the terminal may collect multiple target images. The real scenes included in the multiple target images may form a complete scene where the terminal is currently disposed.

Optionally, the terminal may collect the target image corresponding to the real scene, and send the target image to a server. The server constructs the target three-dimensional coordinate system of the real scene based on the target image, establishes the mapping relationship between the target three-dimensional coordinate system and the virtual three-dimensional coordinate system of the interface displaying the virtual scene, and create the virtual scene corresponding to the target image based on the mapping relationship. The virtual scene is sent to the terminal, and the terminal receives the virtual scene sent by the server.

In a possible implementation, the terminal is provided with a camera, through which the real scene may be photographed to acquire the target image. The virtual scene corresponding to the real scene is created based on the real scene included in the target image.

For example, when the terminal collects the target image through the camera, the user may hold the terminal and surround a currently located real scene for photographing, and the terminal may acquire multiple target images including the real scene. Then the virtual scene corresponding to the real scene is created based on the multiple target images.

In addition, the terminal creates the virtual scene based on the real scene, which may be implemented based on the AR technology. When the terminal moves in the real scene, the corresponding position of the corresponding terminal in the virtual scene will also change.

Moreover, in the embodiment of the present disclosure, at least one virtual sound box may be displayed in the virtual scene, and the virtual sound box may be arranged in the virtual scene by any of the following ways:

Firstly, at least one candidate virtual sound box is displayed in a floating window in a display interface of the virtual scene. In response to a drag operation for any one displayed candidate virtual sound box, the any one candidate virtual sound box is displayed in a release position of the drag operation in the virtual scene.

The floating window is set by a developer, or set by the terminal, or set in other ways.

In addition, the floating window may be dragged by the user to change the display position, and the size may also be changed by the user, or the floating window may be set in other ways.

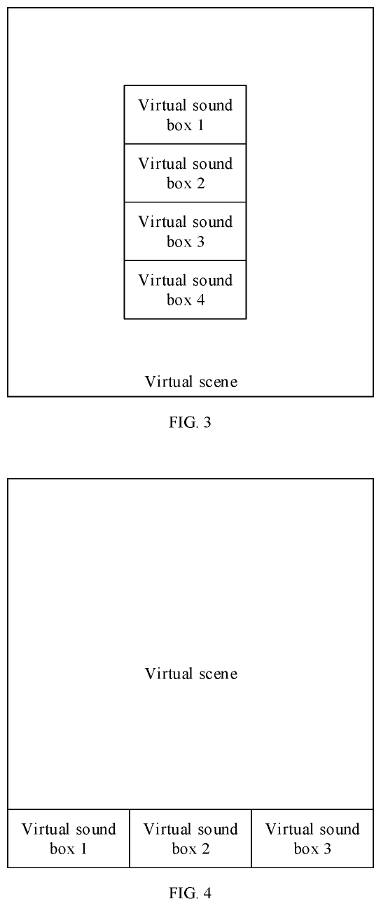

For example, as shown in FIG. 3, the floating window is displayed in the center of the display interface in a floating manner, and 4 virtual sound boxes, which are a virtual sound box 1, a virtual sound box 2, a virtual sound box 3 and a virtual sound box 4 respectively, are displayed from top to bottom in the floating window.

The display interface is a display interface of a target application of the terminal. The target application is an application installed in the terminal, and the target application is audio play application, a reality simulation application, or other types of applications.

In the embodiment of the present disclosure, the terminal displays the virtual scene, and the user may arrange the virtual sound box in the virtual scene. Optionally, the terminal displays at least one candidate virtual sound box in the floating window in the display interface displaying the virtual scene. If the drag operation for any one candidate virtual sound box is detected, in response to the drag operation, the dragged virtual sound box is displayed at the release position of the drag operation in the virtual scene.

In addition, the user needs to adjust the position of the virtual sound box in the virtual scene, and may also trigger the drag operation again. The virtual sound box is dragged through the drag operation until the virtual sound box is displayed at the release position of the drag operation, thereby realizing the effect of adjusting the position of the virtual sound box in the virtual scene.

Secondly, in response to a touch operation for the target position of the virtual scene, at least one candidate virtual sound box is displayed in the floating window in the display interface of the virtual scene. In response to a selection operation for any one displayed candidate virtual sound box, the any one candidate virtual sound box is displayed at the target position.

In the case that the user needs to arrange the virtual sound box in the virtual scene, the terminal displays the virtual scene in the display interface, and the user may execute the touch operation at the target position of the virtual scene. The terminal detects the touch operation for the target position of the virtual scene. In response to the touch operation for the target position of the virtual scene, the terminal displays at least one candidate virtual sound box in the floating window in the display interface of the virtual scene. The user may select one virtual sound box from the at least one candidate virtual sound box, and then the terminal displays the selected virtual sound box at the target position in response to the selection operation for any one displayed candidate virtual sound box.

The touch operation is a click operation, a long-press operation or other types of operations.

Thirdly, at least one candidate virtual sound box is displayed in the floating window in the display interface of the virtual scene. In response to the selection operation for any one displayed candidate virtual sound box, the any one candidate virtual sound box is set to a selected state. In response to the touch operation for the target position of the virtual scene, the virtual sound box in the selected state is displayed at the target position.

In the embodiment of the present disclosure, the terminal displays the virtual scene, and the user may arrange the virtual sound box in the virtual scene. Optionally, the terminal displays at least one candidate virtual sound box in the floating window in the display interface displaying the virtual scene. The user selects one virtual sound box from the at least one candidate virtual sound box. After the terminal detects the selection operation of the virtual sound box, the virtual sound box is set to the selected state, and the user then executes the touch operation at the target position of the virtual scene. The terminal displays the virtual sound box in the selected state at the target position in response to the touch operation for the target position of the virtual scene.

The touch operation is a click operation, a long-press operation or other types of operations.

In a possible implementation, at least one candidate virtual sound box and audio effect of each candidate virtual sound box are displayed in the floating window in the display interface of the virtual scene. The terminal plays the audio based on the audio effect of the candidate virtual sound box in response to a trigger operation for the audio effect of any one candidate virtual sound box. Then the user can hear the audio effect of the candidate virtual sound box and decides whether to select the candidate virtual sound box.

The trigger operation is a single-click operation, a long-press operation or other operations.

In the embodiment of the present disclosure, the audio effects corresponding to different candidate virtual sound boxes may be the same or different. In a case that the audio effects corresponding to different candidate virtual sound boxes are different, when at least one candidate virtual sound box is displayed in the floating window in the display interface of the virtual scene, the audio effect of each candidate virtual sound box may also be displayed. When selecting the candidate virtual sound box, the user may select the virtual sound box based on the audio effect of each candidate virtual sound box.

In another possible implementation, if at least one candidate virtual sound box is displayed in the floating window in the display interface of the virtual scene, in response to the trigger operation for any one of the at least one candidate virtual sound box, audio corresponding to the audio effect of the any one candidate virtual sound box may be played.

The audio may be preset audio for the audio effect of the any candidate virtual sound box, or any audio selected at random, or audio currently being played, or other audios.

The trigger operation is a single-click operation, a double-click operation, a long-press operation, or other types of operations.

Optionally, the terminal may also delete any virtual sound box in the virtual scene in response to a deletion operation for the virtual sound box.

In addition, in the embodiment of the present disclosure, when being displayed, the at least one candidate virtual sound box does not need to be displayed in the floating window of the display interface. The at least one candidate virtual sound box may be displayed in a preset area of the display interface. The preset area is set by the developer, or set by the terminal, or set in other ways.

For example, the preset area may be displayed on the upper side of the display interface, or displayed on the left side of the display interface, or displayed on the lower side of the display interface, or displayed on the right side of the display interface, or displayed in other positions of the display interface.

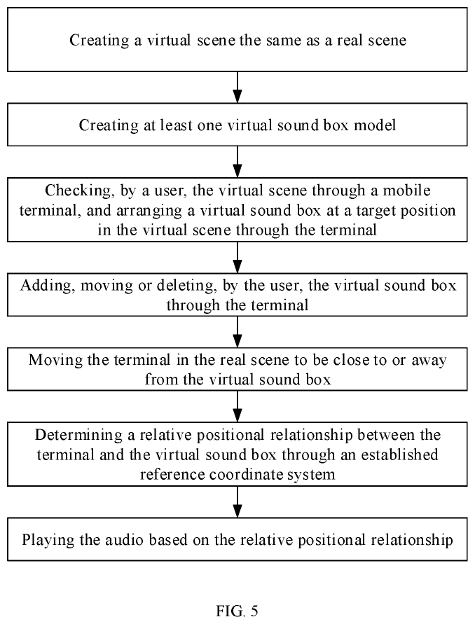

For example, as shown in FIG. 4, the preset area is displayed on the lower side of the display interface, and the preset area includes three virtual sound boxes, which are a virtual sound box 1, a virtual sound box 2, and a virtual sound box 3 respectively.

It should be noted that before step 201, the method further includes: acquiring at least one three-dimensional model. At least one virtual sound box is acquired by respectively creating a virtual sound box that matches the at least one three-dimensional model in the virtual scene.

In addition, before the virtual sound box is displayed in the virtual scene, the virtual sound box needs to be constructed. Constructing the virtual sound box includes: acquiring, by the terminal, at least one three-dimensional model, and acquiring at least one virtual sound box by respectively creating the virtual sound box that matches the at least one three-dimensional model in the virtual scene. The three-dimensional model is a model of the virtual sound box when in display. For example, the three-dimensional model is a three-dimensional model in a mushroom shape, an apple shape, a peach shape or other shapes.

It should be noted that the foregoing embodiment is only described by taking the case that the user arranges the virtual sound box in the current virtual scene as an example. In another embodiment, the terminal may also acquire a stored position of the virtual sound box in the virtual scene from the server, and display the virtual sound box in the virtual scene and the virtual scene based on the acquired position of the virtual sound box.

Optionally, acquiring the stored position of the virtual sound box in the virtual scene from the server includes: displaying an identifier of at least one audio play effect corresponding to the virtual scene, and acquiring a position of any one virtual sound box in the virtual scene in response to a selection operation for the identifier of any one audio play effect.

The identifier is configured to indicate an effect when the audio is played through at least one virtual sound box in the virtual scene. The identifier of the audio play effect is an icon, a button or other identifiers.

In the embodiment of the present disclosure, when currently in one real scene, the terminal may display the identifier of at least one audio play effect of the virtual scene corresponding to the real scene, and the virtual sound boxes corresponding to different audio play effects have different positions in the virtual scene. The user may select one audio play effect from the at least one audio play effect. The terminal detects the selection operation for the identifier of the audio play effect, acquires the position of at least one virtual sound box corresponding to the audio play effect in the virtual scene in response to the selection operation for the identifier of the audio play effect, and further correspondingly displays the virtual sound box at the position of each virtual sound box in the virtual scene.

The selection operation is a single-click operation, a double-click operation, a long-press operation, or other types of operations.

In addition, in the process of displaying the identifier of at least one audio play effect corresponding to the virtual scene, the terminal may also show the position of the virtual sound box included in each audio play effect in the virtual scene in the display interface in advance. Then the user may select one audio play effect based on the position of the at least one virtual sound box corresponding to each audio play effect in the virtual scene.

The above embodiment only describes that the terminal may acquire the position of at least one virtual sound box in the virtual scene from the server. But before the above step, the terminal also needs to acquire the position of the at least one virtual sound box set in the virtual scene in advance. The position of the at least one virtual sound box in the virtual scene is sent to the server, and the server stores the position of the at least one virtual sound box in the virtual scene. After acquiring and determining the position of the at least one virtual sound box in the virtual scene, the terminal sends the position of the at least one virtual sound box in the virtual scene to the server.

The terminal acquires the position of the at least one virtual sound box in the virtual scene, and after detecting a saving operation, sends the position of the at least one virtual sound box in the virtual scene to the server. The server stores the position of the at least one virtual sound box in the virtual scene, so that the terminal subsequently continues to acquire the stored position of the virtual sound box in the virtual scene from the server.

The terminal sends the position of the at least one virtual sound box in the virtual scene to the server, which needs to be performed when the saving operation is detected. Optionally, the terminal displays a saving option in the virtual scene. If the user executes a trigger operation for the saving option, the terminal detects the trigger operation for the saving option, and determines the position of the at least one virtual sound box in the virtual scene in response to the trigger operation for the saving option.

In step 202: a reference coordinate system is established in the virtual scene.

In the embodiment of the present disclosure, each virtual sound box in the at least one virtual sound box has a position in the virtual scene, and the terminal also has a corresponding position in the virtual scene. Then based on the position of the at least one virtual sound box in the virtual scene and the corresponding position of the terminal in the virtual scene, a relative positional relationship between at least one virtual sound box and the terminal is determined. Further, a volume parameter of each virtual sound box is adjusted based on the relative positional relationship, thereby determining an adjusted position volume parameter of each virtual sound box.

If the position of each virtual sound box in the virtual scene needs to be determined, a reference coordinate system is established in the virtual scene, and then the position of each virtual sound box in the reference coordinate system may be determined.

The reference coordinate system is configured to indicate the position of each virtual sound box in the virtual scene. For example, a reference coordinate system is established with the position of the terminal as an original point, or with a position of any virtual sound box as the original point, or with any position as the original point, which is not limited in the embodiment of the present disclosure.

In step 203: coordinates of at least one virtual sound box in the reference coordinate system and coordinates of a terminal in the reference coordinate system are determined based on the reference coordinate system.

After the terminal establishes the reference coordinate system in the virtual scene, each virtual sound box or the terminal has a corresponding position in the reference coordinate system. Therefore, the coordinates of at least one virtual sound box in the reference coordinate system and the coordinates of the terminal in the reference coordinate system are acquired based on the reference coordinate system.

For example, the reference coordinate system is a three-dimensional coordinate system, and the reference coordinate system is established with the position of the terminal as the original point, then the coordinates of the terminal in the reference coordinate system are (0, 0, 0), and the positions of other virtual sound boxes in the reference coordinate system are determined with the terminal as the original point.

It should be noted that the embodiment of the present disclosure is only described by taking the case that the position of the terminal in the virtual scene is directly determined in the reference coordinate system as an example. In another embodiment, the terminal displays the virtual scene acquired based on the real scene, the position of the terminal in the real scene is mapped to the virtual scene, and the corresponding position of the terminal in the virtual scene is acquired. It is not limited to the manner of determining the position of the terminal in the virtual scene by means of establishing the reference coordinate system.

In step 204: a relative positional relationship between the at least one virtual sound box and the terminal is determined based on the coordinates of the at least one virtual sound box in the reference coordinate system and the coordinates of the terminal in the reference coordinate system.

In the embodiment of the present disclosure, each virtual sound box in the at least one virtual sound box and the terminal have the relative positional relationship. Through the above step, the coordinates of each virtual sound box and the coordinates of the terminal may be determined. Then based on the coordinates of the virtual sound box and the coordinates of the terminal, the relative positional relationship between each virtual sound box and the terminal may be determined.

The relative positional relationship is configured to indicate a distance between the virtual sound box and the terminal, an orientation between the virtual sound box and the terminal, or other relationships.

For example, the relative positional relationship is configured to indicate that the virtual sound box is on a left side of the terminal, or the virtual sound box is on a lower right side of the terminal, or the virtual sound box is in other positions of the terminal.

Optionally, when the relative positional relationship between each virtual sound box and the terminal is determined, an angle of the terminal relative to the virtual sound box and a distance between the terminal and each virtual sound box may be determined based on the coordinates of the virtual sound box and the coordinates of the terminal.

In the embodiment of the present disclosure, the position of the terminal in the real scene is mapped to the virtual scene, so that when the position of the terminal in the real scene changes, the position of the terminal in the virtual scene will also change with the change of the position in the real scene. Then the relative positional relationship between the terminal and each virtual sound box will also change.

In step 205: a volume parameter of the at least one virtual sound box is adjusted based on the relative positional relationship between the at least one virtual sound box and the terminal in the virtual scene.

In the embodiment of the present disclosure, the volume parameter of each virtual sound box is adjusted based on the relative positional relationship between the at least one virtual sound box and the terminal, and the adjusted volume parameter of the at least one virtual sound box can be determined.

The volume parameter of the virtual sound box is configured to indicate the volume when the virtual sound box plays audio. In the embodiment of the present disclosure, due to the relative positional relationship between each virtual sound box and the terminal, in a case that each virtual sound box plays the audio, the volume is different when the audio is transmitted to the position of the terminal. Therefore, the volume parameter of each virtual sound box needs to be adjusted based on relative positional relationships between each virtual sound box and the terminal, so that the adjusted volume parameter conforms to the distance and angle between the virtual sound box and the terminal, and an effect that the volume of the audio heard by the user at the position of the terminal will change with the movement of the terminal may be achieved.

Optionally, the angle of the terminal relative to each virtual sound box and the distance between the terminal and each virtual sound box are determined based on the position of the at least one virtual sound box and the position of the terminal. The volume parameter of each virtual sound box is adjusted based on the angle of the terminal relative to each virtual sound box and the distance between the terminal and each virtual sound box.

Optionally, the volume parameter of the virtual sound box includes a first volume parameter and a second volume parameter. The first volume parameter is configured to indicate a volume of a play sound channel in the virtual sound box, and the second volume parameter is configured to indicate a main volume of the virtual sound box. Adjusting the volume parameter of each virtual sound box based on the angle of the terminal relative to each virtual sound box and the distance between the terminal and each virtual sound box includes:

adjusting the first volume parameter of each virtual sound box based on the angle of the terminal relative to each virtual sound box, and adjusting the second volume parameter of each virtual sound box based on a mode that the distance between the terminal and each virtual sound box is inversely proportional to the second volume parameter.

Based on the angle of the terminal relative to each virtual sound box, the orientation of each virtual sound box at the terminal is determined, and then the volume parameter of the play sound channel of each virtual sound box is adjusted based on the determined orientation, so that the orientation is the orientation of the virtual sound box when the user listens to the audio.

In a possible implementation, the play sound channel of the virtual sound box includes a left sound channel and a right sound channel. If the virtual sound box is disposed on the left side of the terminal, the volume parameter of the left sound channel is proportional to the angle of the terminal relative to each virtual speak box, and the volume parameter of the right sound channel is inversely proportional to the angle of the terminal relative to each virtual sound box. If the virtual sound box is disposed on the right side of the terminal, the volume parameter of the left sound channel is inversely proportional to the angle of the terminal relative to each virtual sound box, and the volume parameter of the right sound channel is proportional to the angle of the terminal relative to each virtual sound box. Therefore, the terminal can adjust the first volume parameter of the left sound channel of each virtual sound box and the first volume parameter of the right sound channel of each virtual sound box based on the angle of the terminal relative to each virtual sound box.

In addition, in the embodiment of the present disclosure, the farther the distance between the terminal and the virtual sound box is, the less the volume parameter of the virtual sound box is. The closer the distance between the terminal and the virtual sound box is, the greater the volume parameter of the virtual sound box is. The volume parameter of the virtual sound box is adjusted based on the distance between the terminal and the virtual sound box, thereby achieving the effect that the farther the distance between the virtual sound box and the terminal is, the lower the volume of the audio heard by the user is, and the closer the distance between the virtual sound box and the terminal is, the greater the volume of the audio heard by the user is can be achieved, and improving the audio effect of the audio played by the terminal is improved.

In the embodiment of the present disclosure, the position of the at least one virtual sound box and the position of the terminal may be both represented by coordinates. By the coordinates of the at least one virtual sound box in the reference coordinate system and the coordinates of the terminal in the reference coordinate system, which are acquired in the above step, the angle of the terminal relative to each virtual sound box and the distance between the terminal and each virtual sound box are determined. Based on the angle of the terminal relative to each virtual sound box and the distance between the terminal and each virtual sound box, the volume parameter of each virtual sound box is adjusted to determine the adjusted volume parameter. In addition, after the volume parameter of each virtual sound box is determined in the embodiment of the present disclosure, the effect is an AR audio effect when the audio is played.

It should be noted that the embodiment of the present disclosure is only described by taking the case that the volume parameter of each virtual sound box is adjusted based on the angle of the terminal relative to each virtual sound box and the distance between the terminal and each virtual sound box as an example. In another embodiment, the terminal may also adjust the volume parameter of each virtual sound box based on the distance between the terminal and each virtual sound box. Or, the terminal adjusts the volume parameter of each virtual sound box based on the angle of the terminal relative to each virtual sound box. The manner in which the terminal adjusts the volume parameter of each virtual sound box is similar to the adjustment manner in the embodiment of the present disclosure, and will not be repeated here.

In step 206: the audio is played based on the volume parameter of the at least one virtual sound box.

The audio is any audio to be played by the terminal. The audio may be stored in the terminal, or the audio may also be stored in the server, or stored in other ways.

Since the volume parameter of each virtual sound box in the embodiment of the present disclosure is determined based on the relative positional relationship between each virtual sound box and the terminal, when the audio is played based on the determined volume parameter of the virtual sound box, the effect of the audio heard by the user is also related to the position of the virtual sound box.

For example, after the virtual sound box and the terminal form the relative positional relationship, if the virtual sound box is on the left side of the terminal, the user may hear the audio from the left side. If the virtual sound box is above the terminal, the user may hear the audio coming from above. When the terminal gradually approaches the virtual sound box, the volume of the audio heard by the user is larger and larger. When the terminal gradually moves away from the virtual sound box, the volume of the audio heard by the user is smaller and smaller.

Optionally, the at least one virtual sound box includes a plurality of virtual sound boxes. The terminal determines the volume parameter of each virtual sound box in the plurality of virtual sound boxes, acquires a mixed volume parameter by mixing the volume parameters of the plurality of virtual sound boxes, and then plays the audio based on the mixed volume parameter.

The terminal may use audio mixing algorithm to mix the volume parameters of the plurality of virtual sound boxes. For example, the audio mixing algorithm includes a linear superposition averaging algorithm, a normalized audio mixing algorithm, a resampling audio mixing algorithm, etc., which is not limited in the embodiment of the present disclosure.

FIG. 5 is a flowchart of a method for playing audio according to an embodiment of the present disclosure. Referring to FIG. 5, the terminal creates the virtual scene the same as the real scene, and creates at least one virtual sound box model. The user may check the virtual scene through a mobile terminal, and arrange the virtual sound box at the target position in the virtual scene through the terminal. In addition, the user may also add, move or delete the virtual sound box through the terminal. If the user moves in the real scene, the terminal will approach or move away from the virtual sound box. Through the established reference coordinate system, the relative positional relationship between the terminal and the virtual sound box may be determined, and the audio is played based on the relative positional relationship.

The embodiment of the present disclosure provides a solution of combining the virtuality and reality to play the audio. The virtual sound box may be arranged in the virtual scene corresponding to the real scene, and the volume parameter of the virtual sound box is adjusted based on the relative positional relationship between the terminal and the virtual sound box. The adjusted volume parameter is configured to play the audio. The AR technology is combined with the audio technology. If the user moves in the real scene, the relative positional relationship between the terminal and the virtual sound box in the virtual scene will change, and the volume parameter of the virtual sound box will also change with the movement of the user. The effect that the user moves in the real scene to listen to the audio played with different volume parameters is achieved, thereby improving the audio play effect and expanding the audio play function.

In addition, the user may customize the arrangement of the virtual sound box in the virtual scene through the terminal so that the audio effect formed by the virtual sound box after the arrangement meets user requirements, and provide a function of customizing the creation of the audio effect, thereby diversifying the audio effect of playing the audio and improving the audio play effect.

In addition, the position of the virtual sound box arranged in the virtual scene can also be stored in the server, and the position of the virtual sound box in the virtual scene can be directly acquired from the server subsequently, thereby improving the efficiency of arranging the virtual sound box in the virtual scene and further improving the audio play effect.

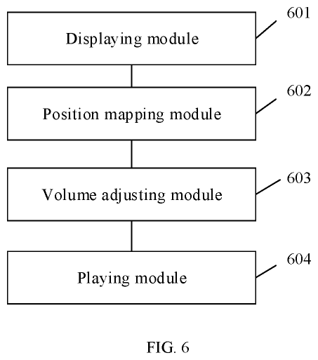

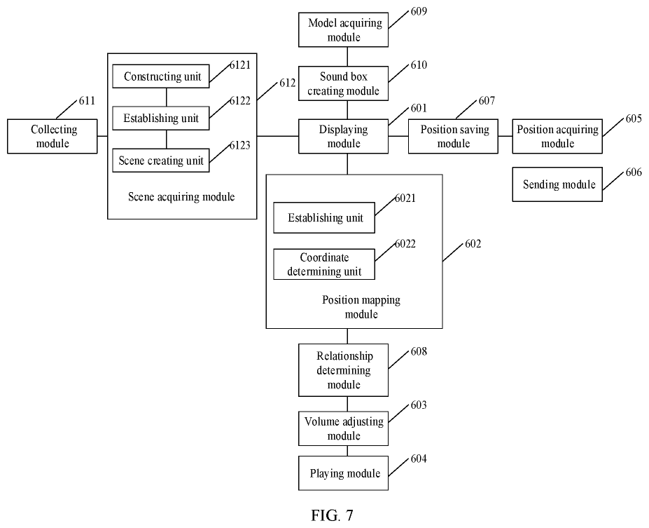

FIG. 6 is a schematic structural diagram of an apparatus for playing audio according to an embodiment of the present disclosure. Referring to FIG. 6, the apparatus includes:

a displaying module 601 configured to display a virtual scene acquired based on a real scene;

a position mapping module 602 configured to acquire a corresponding position of a terminal in the virtual scene by mapping a position of the terminal in the real scene to the virtual scene;

a volume adjusting module 603 configured to, adjust a volume parameter of the at least one virtual sound box based on a relative positional relationship between at least one virtual sound box and the terminal in the virtual scene; and

a playing module 604 configured to play audio based on the volume parameter of the at least one virtual sound box.

The embodiment of the present disclosure provides a solution of combining the virtuality and reality to play the audio. The virtual sound box may be arranged in the virtual scene corresponding to the real scene, and the volume parameter of the virtual sound box is adjusted based on the relative positional relationship between the terminal and the virtual sound box. The adjusted volume parameter is configured to play the audio. The AR technology is combined with the audio technology. If the user moves in the real scene, the relative positional relationship between the terminal and the virtual sound box in the virtual scene will change, and the volume parameter of the virtual sound box will also change with the movement of the user. The effect that the user moves in the real scene to listen to the audio played with different volume parameters is achieved, thereby improving the audio play effect and expanding the audio play function.

Optionally, the displaying module 601 is configured to: display at least one candidate virtual sound box in a floating window in a display interface of the virtual scene;

and display the any one candidate virtual sound box at a release position of the drag operation in the virtual scene, in response to a drag operation for any one displayed candidate virtual sound box.

Optionally, the displaying module 601 is configured to: display at least one candidate virtual sound box in the floating window in the display interface of the virtual scene, in response to a touch operation for the target position of the virtual scene; and display the any one candidate virtual sound box at the target position, in response to a selection operation for any one displayed candidate virtual sound box.

Optionally, the displaying module 601 is configured to: display at least one candidate virtual sound box in the floating window in the display interface of the virtual scene; set the virtual sound box to a selected state in response to the selection operation for any one displayed candidate virtual sound box; and display the virtual sound box in the selected state at the target position, in response to the touch operation for the target position of the virtual scene.

Optionally, the displaying module 601 is configured to display the at least one candidate virtual sound box and audio effect of each candidate virtual sound box in the floating window in the display interface of the virtual scene; and

the playing module 604 is configured to, in response to a trigger operation for the audio effect of any one candidate virtual sound box, play the audio based on the audio effect of the any one candidate virtual sound box.

Optionally, the displaying module 601 is configured to: acquire the position of at least one stored virtual sound box in the virtual scene from a server; and display the virtual sound box corresponding to each position and the virtual scene at the each position acquired in the virtual scene.

Optionally, the displaying module 601 is configured to: display an identifier of at least one audio play effect corresponding to the virtual scene; and acquire the position of the at least one virtual sound box corresponding to the any one audio play effect in the virtual scene, in response to the selection operation for the identifier of any one audio play effect.

Optionally, the apparatus further includes: a position acquiring module 605 configured to acquire the position of at least one virtual sound box set in the virtual scene; and a sending module 606 configured to send the position of the at least one virtual sound box in the virtual scene to the server. The server is configured to store the position of the at least one virtual sound box in the virtual scene.

Optionally, the apparatus further includes: the displaying module 601 configured to display a saving option in the virtual scene; and a position saving module 607 configured to acquire the position of the at least one virtual sound box set in the virtual scene in response to a trigger operation for the saving option.

Optionally, the position mapping module 602 includes: an establishing unit 6021 configured to establish a reference coordinate system in the virtual scene; and a coordinate determining unit 6022 configured to determine coordinates of the at least one virtual sound box in the reference coordinate system and coordinates of the terminal in the reference coordinate system based on the reference coordinate system.

The apparatus further includes: a relationship determining module 608, configured to determine the relative positional relationship between the at least one virtual sound box and the terminal, based on the coordinates of the at least one virtual sound box in the reference coordinate system and the coordinates of the terminal in the reference coordinate system; and

the volume adjusting module 603 is configured to adjust the volume parameter of the at least one virtual sound box, based on the relative positional relationship between the at least one virtual sound box and the terminal.

Optionally, the volume adjusting module 603 is configured to:

determine an angle of the terminal relative to each virtual sound box and a distance between the terminal and each virtual sound box, based on the position of the at least one virtual sound box and the position of the terminal; and

adjust the volume parameter of each virtual sound box, based on the angle of the terminal relative to each virtual sound box and the distance between the terminal and each virtual sound box.

Optionally, the volume parameter of the virtual sound box includes a first volume parameter and a second volume parameter. The first volume parameter is configured to indicate the volume of a play sound channel in the virtual sound box. The second volume parameter is configured to indicate a main volume of the virtual sound box. The volume adjusting module 603 is configured to: adjust the first volume parameter of each virtual sound box, based on the angle of the terminal relative to each virtual sound box; and adjust the second volume parameter of each virtual sound box, based on a mode that the distance between the terminal and each virtual sound box is inversely proportional to the second volume parameter.

Optionally, the playing module 604 is configured to: mix the volume parameters of a plurality of virtual sound boxes to acquire a mixed volume parameter; and play the audio based on the mixed volume parameter.

Optionally, the apparatus further includes: a model acquiring module 609, configured to acquire at least one three-dimensional model; and a sound box creating module 610 configured to, in the virtual scene, respectively create the virtual sound box matching the at least one three-dimensional model to acquire at least one virtual sound box.

Optionally, the apparatus further includes: a collecting module 611 configured to collect a target image corresponding to the real scene; and a scene acquiring module 612 configured to acquire the virtual scene corresponding to the target image.

Optionally, the scene acquiring module 612 includes:

a constructing unit 6121 configured to construct a target three-dimensional coordinate system of the real scene based on the target image;

an establishing unit 6122 configured to establish a mapping relationship between the target three-dimensional coordinate system and a virtual three-dimensional coordinate system of an interface displaying the virtual scene; and

a scene creating unit 6123 configured to create the virtual scene corresponding to the target image.

Optionally, the scene acquiring module 612 is configured to: send the target image to the server; and receive the virtual scene corresponding to the target image sent by the server, and the server is configured to construct the target three-dimensional coordinate system of the real scene based on the target image, establish a mapping relationship between the target three-dimensional coordinate system and the virtual three-dimensional coordinate system of the interface displaying the virtual scene, and create the virtual scene corresponding to the target image based on the mapping relationship.

It should be noted that the apparatus for playing audio according to the above embodiment only takes division of all the functional modules as an example for explanation when playing the audio. In practice, the above functions can be finished by the different functional modules as required. That is, the internal structure of the apparatus is divided into different functional modules to finish all or part of the functions described above. In addition, the apparatus for playing audio according to the above embodiment has the same concept as the method for playing audio according to the foregoing embodiment. The specific implementation process of the method refers to the method embodiment, which will not be repeated herein.

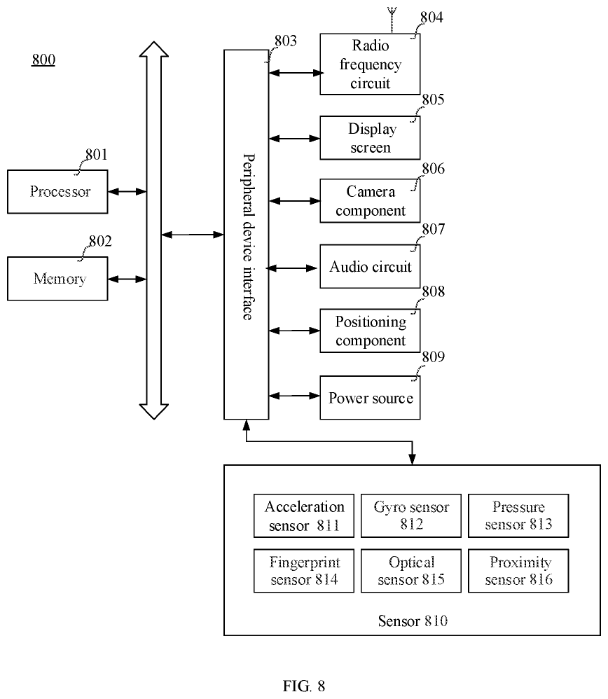

FIG. 8 is a schematic structural diagram of a terminal in accordance with the embodiment of the present disclosure. The terminal 800 may be a portable mobile terminal, such as a smart phone, a tablet computer, a moving picture experts group audio layer III (MP3) player, a moving picture experts group audio layer IV (MP4) player, a laptop or desk computer. The terminal 800 may also be called user equipment (UE), a portable terminal, a laptop terminal, a desk terminal, etc.

Generally, the terminal 800 includes a processor 801 and a memory 802.

The processor 801 may include one or more processing cores, such as a 4-core processor and an 8-core processor. The processor 801 may be formed by at least one hardware of a digital signal processing (DSP), a field-programmable gate array (FPGA), and a programmable logic array (PLA). The processor 801 may also include a main processor and a coprocessor. The main processor is a processor for processing the data in an awake state, and is also called a central processing unit (CPU). The coprocessor is a low-power-consumption processor for processing the data in a standby state. In some embodiments, the processor 801 may be integrated with a graphics processing unit (GPU), which is configured to render and draw the content that needs to be displayed by a display screen. In some embodiments, the processor 801 may also include an artificial intelligence (AI) processor configured to process computational operations related to machine learning.

The memory 802 may include one or more computer-readable storage mediums, which can be non-transitory. The memory 802 may also include a high-speed random access memory, as well as a non-volatile memory, such as one or more disk storage devices and flash storage devices. In some embodiments, the non-transitory computer-readable storage medium in the memory 802 is configured to store at least one instruction. The at least one instruction is configured to be executed by the processor 801 to implement the method for playing audio according to the method embodiment of the present disclosure.

In some embodiments, the terminal 800 also optionally includes a peripheral device interface 803 and at least one peripheral device. The processor 801, the memory 802, and the peripheral device interface 803 may be connected by a bus or a signal line. Each peripheral device may be connected to the peripheral device interface 803 by a bus, a signal line or a circuit board. Specifically, the peripheral device includes at least one of a radio frequency circuit 804, a touch display screen 805, a camera 806, audio circuit 807, a positioning component 808 and a power source 809.

The peripheral device interface 803 may be configured to connect at least one peripheral device associated with an input/output (I/O) to the processor 801 and the memory 802. In some embodiments, the processor 801, the memory 802 and the peripheral device interface 803 are integrated on the same chip or circuit board. In some other embodiments, any one or two of the processor 801, the memory 802 and the peripheral device interface 803 may be implemented on a separate chip or circuit board, which is not limited in the present embodiment.

The radio frequency circuit 804 is configured to receive and transmit a radio frequency (RF) signal, which is also referred to as an electromagnetic signal. The radio frequency circuit 804 communicates with a communication network and other communication devices via the electromagnetic signal. The radio frequency circuit 804 converts the electrical signal into the electromagnetic signal for transmission, or converts the received electromagnetic signal into the electrical signal. Optionally, the radio frequency circuit 804 includes an antenna system, an RF transceiver, one or more amplifiers, a tuner, an oscillator, a digital signal processor, a codec chipset, a subscriber identity module card, and the like. The radio frequency circuit 804 can communicate with other terminals via at least one wireless communication protocol. The wireless communication protocol includes, but not limited to, the World Wide Web, a metropolitan area network, an intranet, various generations of mobile communication networks (2G, 3G, 4G, and 5G), a wireless local area network, and/or a wireless fidelity (WiFi) network. In some embodiments, the RF circuit 804 may also include near field communication (NFC) related circuits, which is not limited in the present disclosure.

The display screen 805 is configured to display a user interface (UI). The UI may include graphics, text, icons, videos, and any combination thereof. When the display screen 805 is a touch display screen, the display screen 805 also has the capacity to acquire touch signals on or over the surface of the display screen 805. The touch signal may be input into the processor 801 as a control signal for processing. At this time, the display screen 805 may also be configured to provide virtual buttons and/or virtual keyboards, which are also referred to as soft buttons and/or soft keyboards. In some embodiments, one display screen 805 may be disposed on the front panel of the terminal 800. In some other embodiments, at least two display screens 805 may be disposed respectively on different surfaces of the terminal 800 or in a folded design. In further embodiments, the display screen 805 may be a flexible display screen disposed on the curved or folded surface of the terminal 800. Even the display screen 805 may have an irregular shape other than a rectangle; that is, the display screen 805 may be an irregular-shaped screen. The display screen 805 may be a liquid crystal display (LCD) screen, an organic light-emitting diode (OLED) screen or the like.

The camera component 806 is configured to capture images or videos. Optionally, the camera component 806 includes a front camera and a rear camera. Usually, the front camera is placed on the front panel of the terminal, and the rear camera is placed on the back of the terminal. In some embodiments, at least two rear cameras are disposed, and are at least one of a main camera, a depth-of-field camera, a wide-angle camera, and a telephoto camera respectively, so as to realize a background blurring function achieved by fusion of the main camera and the depth-of-field camera, panoramic shooting and virtual reality (VR) shooting functions achieved by fusion of the main camera and the wide-angle camera or other fusion shooting functions. In some embodiments, the camera component 806 may also include a flashlight. The flashlight may be a mono-color temperature flashlight or a two-color temperature flashlight. The two-color temperature flash is a combination of a warm flashlight and a cold flashlight and can be used for light compensation at different color temperatures.

The audio circuit 807 may include a microphone and a speaker. The microphone is configured to collect sound waves of users and environments, and convert the sound waves into electrical signals which are input into the processor 801 for processing, or input into the RF circuit 804 for voice communication. For the purpose of stereo acquisition or noise reduction, there may be a plurality of microphones respectively disposed at different locations of the terminal 800. The microphone may also be an array microphone or an omnidirectional acquisition microphone. The speaker is then configured to convert the electrical signals from the processor 801 or the radio frequency circuit 804 into the sound waves. The speaker may be a conventional film speaker or a piezoelectric ceramic speaker. When the speaker is the piezoelectric ceramic speaker, the electrical signal can be converted into not only human-audible sound waves but also the sound waves which are inaudible to humans for the purpose of ranging and the like. In some embodiments, the audio circuit 807 may also include a headphone jack.

The positioning component 808 is configured to locate the current geographic location of the terminal 800 to implement navigation or location based service (LBS). The positioning component 808 may be a positioning component based on the American global positioning system (GPS), the Chinese Beidou system, the European Galileo system.

The power source 809 is configured to power up various components in the terminal 800.

The power source 809 may be alternating current, direct current, a disposable battery, or a rechargeable battery. When the power source 809 includes the rechargeable battery, the rechargeable battery may a wired rechargeable battery or a wireless rechargeable battery. The wired rechargeable battery is a battery charged by a cable line, and wireless rechargeable battery is charged by a wireless coil. The rechargeable battery may also support the fast charging technology.

In some embodiments, terminal 800 also includes one or more sensors 810. The one or more sensors 810 include, but not limited to, an acceleration sensor 811, a gyro sensor 812, a pressure sensor 813, a fingerprint sensor 814, an optical sensor 815 and a proximity sensor 816.

The acceleration sensor 811 may detect magnitudes of accelerations on three coordinate axes of a coordinate system established by the terminal 800. For example, the acceleration sensor 811 may be configured to detect components of a gravitational acceleration on the three coordinate axes. The processor 801 may control the touch display screen 805 to display a user interface in a landscape view or a portrait view according to a gravity acceleration signal collected by the acceleration sensor 811. The acceleration sensor 811 may also be configured to collect motion data of a game or a user.

The gyro sensor 812 can detect a body direction and a rotation angle of the terminal 800, and can cooperate with the acceleration sensor 811 to collect a 3D motion of the user on the terminal 800. Based on the data collected by the gyro sensor 812, the processor 801 can serve the following functions: motion sensing (such as changing the UI according to a user's tilt operation), image stabilization during shooting, game control and inertial navigation.

The pressure sensor 813 may be disposed on a side frame of the terminal 800 and/or a lower layer of the touch display screen 805. When the pressure sensor 813 is disposed on the side frame of the terminal 800, a user's holding signal to the terminal 800 can be detected. The processor 801 can perform left-right hand recognition or quick operation according to the holding signal collected by the pressure sensor 813. When the pressure sensor 813 is disposed on the lower layer of the touch display screen 805, the processor 801 controls an operable control on the UI according to a user's pressure operation on the touch display screen 805. The operable control includes at least one of a button control, a scroll bar control, an icon control and a menu control.

The fingerprint sensor 814 is configured to collect a user's fingerprint. The processor 801 identifies the user's identity based on the fingerprint collected by the fingerprint sensor 814, or the fingerprint sensor 814 identifies the user's identity based on the collected fingerprint. When the user's identity is identified as trusted, the processor 801 authorizes the user to perform related sensitive operations, such as unlocking the screen, viewing encrypted information, downloading software, paying, and changing settings. The fingerprint sensor 814 may be provided on the front, back, or side of the terminal 800. When the terminal 800 is provided with a physical button or a manufacturer's Logo, the fingerprint sensor 814 may be integrated with the physical button or the manufacturer's Logo.

The optical sensor 815 is configured to collect ambient light intensity. In one embodiment, the processor 801 may control the display brightness of the touch display screen 805 according to the ambient light intensity collected by the optical sensor 815. Specifically, when the ambient light intensity is high, the display brightness of the touch display screen 805 is increased; and when the ambient light intensity is low, the display brightness of the touch display screen 805 is decreased. In another embodiment, the processor 801 may also dynamically adjust shooting parameters of the camera component 806 according to the ambient light intensity collected by the optical sensor 815.

The proximity sensor 816, also referred to as a distance sensor, is usually disposed on the front panel of the terminal 800. The proximity sensor 816 is configured to capture a distance between the user and a front surface of the terminal 800. In one embodiment, when the proximity sensor 816 detects that the distance between the user and the front surface of the terminal 800 becomes gradually smaller, the processor 801 controls the touch display screen 805 to switch from a screen-on state to a screen-off state. When it is detected that the distance between the user and the front surface of the terminal 800 gradually increases, the processor 801 controls the touch display screen 805 to switch from the screen-off state to the screen-on state.

It will be understood by those skilled in the art that the structure shown in FIG. 8 does not constitute a limitation to the terminal 800, and may include more or less components than those illustrated, or combine some components or adopt different component arrangements.

The embodiment of the present disclosure also provides a terminal. The terminal includes a processor and a memory. At least one program code is stored in the memory, and the at least one program code is loaded and executed by the processor to implement the following operations of:

displaying a virtual scene acquired based on a real scene;

acquiring a corresponding position of the terminal in the virtual scene by mapping a position of the terminal in the real scene to the virtual scene;

adjusting a volume parameter of the at least one virtual sound box, based on a relative positional relationship between at least one virtual sound box and the terminal in the virtual scene; and

playing audio based on the volume parameter of the at least one virtual sound box.

In a possible implementation, the at least one program code is loaded and executed by the processor to implement the following operations of:

displaying at least one candidate virtual sound box in a floating window in a display interface of the virtual scene; and

displaying the any one candidate virtual sound box at a release position of the drag operation in the virtual scene, in response to a drag operation for any one displayed candidate virtual sound box.

In a possible implementation, the at least one program code is loaded and executed by the processor to implement the following operations of:

displaying at least one candidate virtual sound box in the floating window in the display interface of the virtual scene in response to a touch operation for the target position of the virtual scene; and

displaying the any one candidate virtual sound box at the target position in response to a selection operation for any one displayed candidate virtual sound box.

In a possible implementation, the at least one program code is loaded and executed by the processor to implement the following operations of:

displaying at least one candidate virtual sound box in the floating window in the display interface of the virtual scene;

setting the any one candidate virtual sound box to a selected state in response to the selection operation for any one displayed candidate virtual sound box; and

displaying the virtual sound box in the selected state at the target position in response to the touch operation for the target position of the virtual scene.

In a possible implementation, the at least one program code is loaded and executed by the processor to implement the following operation of:

displaying the at least one candidate virtual sound box and audio effect of each candidate virtual sound box in the floating window in the display interface of the virtual scene; and

after displaying the at least one candidate virtual sound box and the audio effect of each candidate virtual sound box in the floating window in the display interface of the virtual scene, the method further includes:

playing the audio based on the audio effect of any one candidate virtual sound box in response to a trigger operation for the audio effect of any one candidate virtual sound box.

In a possible implementation, the at least one program code is loaded and executed by the processor to implement the following operations of:

acquiring the position of at least one stored virtual sound box in the virtual scene from a server; and

displaying the virtual sound box corresponding to each position and the virtual scene at each position acquired in the virtual scene.

In a possible implementation, the at least one program code is loaded and executed by the processor to implement the following operations of:

displaying an identifier of at least one audio play effect corresponding to the virtual scene; and

acquiring the position of the at least one virtual sound box corresponding to the any one audio play effect in the virtual scene in response to the selection operation for the identifier of any one audio play effect.

In a possible implementation, the at least one program code is loaded and executed by the processor to implement the following operations of:

acquiring the position of at least one virtual sound box set in the virtual scene; and

sending the position of the at least one virtual sound box in the virtual scene to the server;

wherein the server is configured to store the position of the at least one virtual sound box in the virtual scene.

In a possible implementation, the at least one program code is loaded and executed by the processor to implement the following operations of:

displaying a saving option in the virtual scene; and

acquiring the position of the at least one virtual sound box set in the virtual scene in response to a trigger operation for the saving option.

In a possible implementation, the at least one program code is loaded and executed by the processor to implement the following operations of:

establishing a reference coordinate system in the virtual scene; and

determining coordinates of the at least one virtual sound box in the reference coordinate system and coordinates of the terminal in the reference coordinate system based on the reference coordinate system.

The at least one program code is loaded and executed by the processor to implement the following operations of:

determining the relative positional relationship between the at least one virtual sound box and the terminal, based on the coordinates of the at least one virtual sound box in the reference coordinate system and the coordinates of the terminal in the reference coordinate system; and

adjusting the volume parameter of the at least one virtual sound box, based on the relative positional relationship between the at least one virtual sound box and the terminal.

In a possible implementation, the at least one program code is loaded and executed by the processor to implement the following operations of:

determining an angle of the terminal relative to each virtual sound box and a distance between the terminal and each virtual sound box, based on the position of the at least one virtual sound box and the position of the terminal; and

adjusting the volume parameter of each virtual sound box, based on the angle of the terminal relative to each virtual sound box and the distance between the terminal and each virtual sound box.

In a possible implementation, the volume parameter of the virtual sound box includes a first volume parameter and a second volume parameter, the first volume parameter is configured to indicate the volume of a play sound channel in the virtual sound box, and the second volume parameter is configured to indicate a main volume of the virtual sound box; and the at least one program code is loaded and executed by the processor to implement the following operations of:

adjusting the first volume parameter of each virtual sound box, based on the angle of the terminal relative to each virtual sound box; and

adjusting the second volume parameter of each virtual sound box, based on a mode that the distance between the terminal and each virtual sound box is inversely proportional to the second volume parameter.

In a possible implementation, the at least one program code is loaded and executed by the processor to implement the following operations of:

acquiring a mixed volume parameter by mixing the volume parameters of a plurality of virtual sound boxes; and

playing the audio based on the mixed volume parameter.

In a possible implementation, the at least one program code is loaded and executed by the processor to implement the following operations of:

acquiring at least one three-dimensional model; and

acquiring at least one virtual sound box by respectively creating the virtual sound box matching the at least one three-dimensional model in the virtual scene.

In a possible implementation, the at least one program code is loaded and executed by the processor to implement the following operation of:

collecting a target image corresponding to the real scene, and acquiring the virtual scene corresponding to the target image.

In a possible implementation, the at least one program code is loaded and executed by the processor to implement the following operations of:

constructing a target three-dimensional coordinate system of the real scene based on the target image;

establishing a mapping relationship between the target three-dimensional coordinate system and a virtual three-dimensional coordinate system of an interface displaying the virtual scene; and

acquiring the virtual scene corresponding to the target image based on the mapping relationship.

In a possible implementation, the at least one program code is loaded and executed by the processor to implement the following operations of:

sending the target image to the server; and

receiving the virtual scene corresponding to the target image sent by the server, the server being configured to construct the target three-dimensional coordinate system of the real scene based on the target image, establishing a mapping relationship between the target three-dimensional coordinate system and the virtual three-dimensional coordinate system of the interface displaying the virtual scene, and creating the virtual scene corresponding to the target image based on the mapping relationship.

The embodiment of the present disclosure also provides a computer-readable storage medium. The computer-readable storage medium stores at least one program code therein. The at least one program code is loaded and executed by a processor to implement the operations executed in the method for playing audio according to the above embodiment.

The embodiment of the present disclosure also provides a computer program product or computer program. The computer program product or computer program includes a computer program code. The computer program code is stored in a computer-readable storage medium. The processor of a terminal reads the computer program code from the computer-readable storage medium. The processor executes the computer program code, so that the terminal implements the operations executed in the method for playing audio according to the above embodiment.

Persons of ordinary skill in the art can understand that all or part of the steps of the above embodiments can be completed through hardware, or through relevant hardware instructed by programs stored in a computer-readable storage medium, such as a read-only memory, a disk or a CD, etc.

The foregoing descriptions are merely preferred embodiments of the present disclosure, and are not intended to limit the present disclosure. Within the spirit and principles of the present disclosure, any modifications, equivalent substitutions, improvements, etc., are within the protection scope of the present disclosure.

1. A method for playing audio, applicable to a terminal and comprising:
displaying a virtual scene acquired based on a real scene;
acquiring a corresponding position of the terminal in the virtual scene by mapping a position of the terminal in the real scene to the virtual scene;
adjusting a volume parameter of at least one virtual sound box based on a relative positional relationship between the at least one virtual sound box and the terminal in the virtual scene; and
playing audio based on the volume parameter of the at least one virtual sound box.

2. The method according to claim 1, wherein before adjusting the volume parameter of the at least one virtual sound box based on the relative positional relationship between the at least one virtual sound box and the terminal in the virtual scene, the method further comprises:
displaying at least one candidate virtual sound box in a floating window in a display interface of the virtual scene; and
displaying any one candidate virtual sound box at a release position of a drag operation in the virtual scene in response to the drag operation for the any one displayed candidate virtual sound box.

3. The method according to claim 1, wherein before adjusting the volume parameter of the at least one virtual sound box based on the relative positional relationship between the at least one virtual sound box and the terminal in the virtual scene, the method further comprises:
displaying at least one candidate virtual sound box in a floating window in a display interface of the virtual scene in response to a touch operation for a target position of the virtual scene; and
displaying any one candidate virtual sound box at the target position in response to a selection operation for the any one displayed candidate virtual sound box.

4. The method according to claim 1, wherein before adjusting the volume parameter of the at least one virtual sound box based on the relative positional relationship between the at least one virtual sound box and the terminal in the virtual scene, the method further comprises:
displaying at least one candidate virtual sound box in a floating window in a display interface of the virtual scene;
setting any one candidate virtual sound box to a selected state in response to a selection operation for the any one displayed candidate virtual sound box; and
displaying the virtual sound box in the selected state at a target position in response to a touch operation for the target position of the virtual scene.

5. The method according to claim 2, wherein displaying the at least one candidate virtual sound box in the floating window in the display interface of the virtual scene comprises:
displaying the at least one candidate virtual sound box and audio effect of each candidate virtual sound box in the floating window in the display interface of the virtual scene; and
after displaying the at least one candidate virtual sound box and the audio effect of each candidate virtual sound box in the floating window in the display interface of the virtual scene, the method further comprises:
playing the audio based on the audio effect of the any one candidate virtual sound box in response to a trigger operation for the audio effect of any one candidate virtual sound box.

6. The method according to claim 1, wherein displaying the virtual scene acquired based on the real scene comprises:
acquiring a position of at least one stored virtual sound box in the virtual scene from a server; and
displaying the virtual sound box and the virtual scene, which correspond to each position acquired in the virtual scene, at the each position.

7. The method according to claim 6, wherein acquiring the position of the at least one stored virtual sound box in the virtual scene from the server comprises:
displaying an identifier of at least one audio play effect corresponding to the virtual scene; and
acquiring a position of at least one virtual sound box corresponding to the at least one audio play effect in the virtual scene in response to a selection operation for the identifier of the the at least one audio play effect.

8. The method according to claim 6, before acquiring the position of the at least one stored virtual sound box in the virtual scene from the server, the method further comprises:
acquiring a position of at least one virtual sound box set in the virtual scene; and
sending the position of the at least one virtual sound box in the virtual scene to the server;
wherein the server is configured to store the position of the at least one virtual sound box in the virtual scene.

9. The method according to claim 8, wherein before acquiring the position of the at least one virtual sound box set in the virtual scene, the method further comprises:
displaying a saving option in the virtual scene; and
acquiring the position of the at least one virtual sound box set in the virtual scene in response to a trigger operation for the saving option.

10. The method according to claim 1, wherein acquiring the corresponding position of the terminal in the virtual scene by mapping the position of the terminal in the real scene to the virtual scene comprises:
establishing a reference coordinate system in the virtual scene; and
determining coordinates of the at least one virtual sound box in the reference coordinate system and coordinates of the terminal in the reference coordinate system based on the reference coordinate system; and
adjusting the volume parameter of the at least one virtual sound box based on the relative positional relationship between the at least one virtual sound box and the terminal in the virtual scene comprises:
determining a relative positional relationship between the at least one virtual sound box and the terminal based on the coordinates of the at least one virtual sound box in the reference coordinate system and the coordinates of the terminal in the reference coordinate system; and
adjusting the volume parameter of the at least one virtual sound box based on the relative positional relationship between the at least one virtual sound box and the terminal.

11. The method according to claim 1, wherein adjusting the volume parameter of the at least one virtual sound box based on the relative positional relationship between the at least one virtual sound box and the terminal in the virtual scene comprises:
determining an angle of the terminal relative to each virtual sound box and a distance between the terminal and each virtual sound box based on the position of the at least one virtual sound box and the position of the terminal; and
adjusting the volume parameter of each virtual sound box based on the angle of the terminal relative to each virtual sound box and the distance between the terminal and each virtual sound box.

12. The method according to claim 11, wherein the volume parameter of the virtual sound box comprises a first volume parameter and a second volume parameter, the first volume parameter is configured to indicate a volume of a play sound channel in the virtual sound box, and the second volume parameter is configured to indicate a main volume of the virtual sound box; and
adjusting the volume parameter of each virtual sound box based on the angle of the terminal relative to each virtual sound box and the distance between the terminal and each virtual sound box comprises:
adjusting the first volume parameter of each virtual sound box based on the angle of the terminal relative to each virtual sound box; and
adjusting the second volume parameter of each virtual sound box based on a mode that the distance between the terminal and each virtual sound box is inversely proportional to the second volume parameter.

13. The method according to claim 1, wherein the at least one virtual sound box comprises a plurality of virtual sound boxes; and
playing the audio based on the volume parameter of the at least one virtual sound box comprises:
acquiring a mixed volume parameter by mixing volume parameters of the plurality of virtual sound boxes; and
playing the audio based on the mixed volume parameter.

14. The method according to claim 1, wherein before displaying the virtual scene acquired based on the real scene, the method further comprises:
acquiring at least one three-dimensional model; and
acquiring at least one virtual sound box by respectively creating the virtual sound box matching the at least one three-dimensional model in the virtual scene.

15. The method according to claim 1, wherein before displaying the virtual scene acquired based on the real scene, the method further comprises:
collecting a target image corresponding to the real scene, and acquiring the virtual scene corresponding to the target image.

16. The method according to claim 15, wherein acquiring the virtual scene corresponding to the target image comprises:
constructing a target three-dimensional coordinate system of the real scene based on the target image;
establishing a mapping relationship between the target three-dimensional coordinate system and a virtual three-dimensional coordinate system of an interface displaying the virtual scene; and
acquiring the virtual scene corresponding to the target image based on the mapping relationship.

17. The method according to claim 15, wherein acquiring the virtual scene corresponding to the target image comprises:
sending the target image to a server; and
receiving the virtual scene corresponding to the target image sent by the server, wherein the server is configured to construct the target three-dimensional coordinate system of the real scene based on the target image, establish a mapping relationship between the target three-dimensional coordinate system and the virtual three-dimensional coordinate system of the interface displaying the virtual scene, and create the virtual scene corresponding to the target image based on the mapping relationship.

18. A terminal, comprising a processor and a memory, wherein at least one program code is stored in the memory, and the at least one program code is loaded and executed by the processor to implement the following operations of:
displaying a virtual scene acquired based on a real scene;
acquiring a corresponding position of the terminal in the virtual scene by mapping a position of the terminal in the real scene to the virtual scene;
adjusting a volume parameter of at least one virtual sound box based on a relative positional relationship between the at least one virtual sound box and the terminal in the virtual scene; and
playing audio based on the volume parameter of the at least one virtual sound box.

19. The terminal according to claim 18, wherein the at least one program code is loaded and executed by the processor to implement the following operations of:
determining an angle of the terminal relative to each virtual sound box and a distance between the terminal and each virtual sound box based on the position of the at least one virtual sound box and the position of the terminal; and
adjusting the volume parameter of each virtual sound box based on the angle of the terminal relative to each virtual sound box and the distance between the terminal and each virtual sound box.

20. A computer-readable storage medium, wherein at least one program code is stored in the computer-readable storage medium, and the at least one program code is loaded and executed by a processor to implement the following operations of:
displaying a virtual scene acquired based on a real scene;
acquiring a corresponding position of the terminal in the virtual scene by mapping a position of the terminal in the real scene to the virtual scene;
adjusting a volume parameter of at least one virtual sound box based on a relative positional relationship between the at least one virtual sound box and the terminal in the virtual scene; and
playing audio based on the volume parameter of the at least one virtual sound box.
